(19) United States
(12) Patent Application Publication
(10) Pub. No.: US 2024/0046327 A1
(43) Pub. Date: Feb. 8, 2024

(54) SYSTEM AND METHOD FOR FACILITATING PRODUCT EXCHANGE TRANSACTIONS

(71) Applicant: Capital One Services, LLC, McLean, VA (US)

(72) Inventors: Xiaoguang ZHU, New York, NY (US); Abdelkader BENKREIRA, Washington, DC (US); Brendan WAY, Brooklyn, NY (US)

(21) Appl. No.: 17/880,378

(22) Filed: Aug. 3, 2022

(51) Int. Cl. G06Q 30/06; G06Q 10/08

(52) U.S. Cl. CPC G06Q 30/0611; G06Q 10/0837

(57) ABSTRACT

In a method of facilitating product exchange transactions, an exchange facilitation system uses product return transaction data to establish a machine learning-based return transaction model using. The exchange facilitation system receives a request to purchase a desired product from a first purchaser user device. The exchange facilitation system determines an exchange offer recommendation using the machine learning-based return transaction model and information from the request to purchase. The recommendation includes an exchange offer including a proposed wait interval duration. The exchange facilitation system transmits the exchange offer to and receives an exchange offer response back from the first purchaser user device. Responsive to receiving a positive exchange offer response, the exchange facilitation system initiates a product exchange wait interval limited to the wait interval duration.

### FIELD OF THE INVENTION

This disclosure relates generally to systems and automated methods for processing product-related transactions and, more particularly to an automated system and method for facilitating direct user-to-user product transfers.

### BACKGROUND OF THE INVENTION

As e-commerce expands, product returns present a growing challenge. E-tailers have the same problems as traditional brick-and-mortar businesses in terms of the time and costs associated with accepting, inspecting and restocking returned items. They also, however, must deal with the problems associated with return shipping/receiving, which can produce significant uncertainty in terms of time, inventory and the potential for damage in transit. The logistics of handling returns as well as new orders far exceeds anything envisioned in the days of traditional mail order commerce. Bringing technology to bear to ease the logistics problems and reduce the handling of returned merchandise is crucial to future e-commerce success.

### SUMMARY OF THE INVENTION

An illustrative aspect of the invention provides a method of facilitating product exchange transactions. The method comprises obtaining, by an exchange facilitation system, product return transaction data for a plurality of product return transactions. The data for each transaction includes purchaser account information and returned product information. The method further comprises establishing, by the exchange facilitation system, a machine learning-based return transaction model using the product return transaction data. The return transaction model is configured to determine an exchange offer recommendation for a given set of product and purchaser characteristics. The method also comprises receiving, by the exchange facilitation system over a network from a first purchaser user device associated with a first purchaser and a first purchaser account, a request to purchase a desired product having desired product characteristics. The exchange facilitation system determines an exchange offer recommendation using the machine learning-based return transaction model and information from the request to purchase. The exchange offer recommendation includes an exchange offer including a proposed product exchange wait interval having a wait interval duration. The method also comprises transmitting, by the exchange facilitation system to the first purchaser user device, an exchange offer notification including the exchange offer, receiving, by the exchange facilitation system from the first purchaser user device, an exchange offer response, and, responsive to receiving a positive exchange offer response, initiating, by the exchange facilitation system, a product exchange wait interval limited to the wait interval duration.

Another aspect of the invention provides an automated exchange facilitation data processing system comprising a modeling data processing system, a product order data processing system, and a product return data processing system. The modeling data processing system is configured to obtain product return transaction data for a plurality of product return transactions. The data for each transaction including purchaser information and returned product information. The modeling data processing system is further configured to establish and maintain a machine learning-based return transaction model using the product return transaction data. The return transaction model is configured to determine an exchange offer recommendation for a given set of product and purchaser characteristics. The product order data processing system is configured to receive, over a network, product order transaction information for a product order request received from a first purchaser user device associated with a first purchaser and a first purchaser account. The product order transaction information includes first purchaser information and desired product information for a desired product having desired product characteristics. The product order data processing system is further configured to obtain, from the modeling data processing system, a first exchange offer recommendation based on the first purchaser information and the desired product information. The product order data processing system is still further configured to establish a first exchange offer based on the first exchange offer recommendation. The first exchange offer includes a proposed product exchange wait interval having a wait interval duration. The product order data processing system is also configured to transmit, to the first purchaser user device, a first exchange offer notification including the first exchange offer, to receive, from the first purchaser user device, a first exchange offer response, and, responsive to receiving a positive exchange offer response, to initiate a product exchange wait interval limited to the wait interval duration. The product return data processing system is configured to receive, over the network, product return transaction information for a product return request received from a second purchaser user device during the product exchange wait interval. The product return transaction information includes second purchaser information and product return information relating to a previously purchased product. The product return data processing system is further configured to determine whether the previously purchased product has the desired product characteristics. Responsive to a determination that the previously purchased product has the desired product characteristics, the product return data processing system obtains, from the modeling data processing system, a second exchange offer recommendation based on the second purchaser information and the product return information and establishes a second exchange offer based on the second exchange offer recommendation. The product return data processing system then transmits, to the second purchaser user device, a second exchange offer notification including the second exchange offer. The product return data processing system is further configured to receive, from the second purchaser user device, a second exchange offer response, and responsive to receiving a positive exchange offer response, transmit exchange instructions to the first and second purchaser user devices.

Another aspect of the invention provides a method of facilitating product exchange transactions. The method comprises receiving, by an exchange facilitation system over a network from a first purchaser user device associated with a first purchaser and a first purchaser account, a request to purchase a desired product. The method further comprises determining, by the exchange facilitation system, desired product information including desired product characteristics for the desired product and obtaining, by the exchange facilitation system from a modeling data processing system running a machine learning-based return transaction model, a product return prediction. The product return prediction includes a probability value indicative of the likelihood of a return of a matching product having the desired product characteristics. the method still further comprises transmitting, by the exchange facilitation system to the first purchaser user device, an exchange offer notification including an exchange offer based on the product return prediction. The exchange offer includes a proposed product exchange wait interval having a wait interval duration. The method also comprises receiving, by the exchange facilitation system from the first purchaser user device, an acceptance of the exchange offer. Responsive to receiving the acceptance, the exchange facilitation system initiates a product exchange wait interval limited to the wait interval duration. the method also comprises receiving, by the exchange facilitation system over the network from a second purchaser user device during the product exchange wait interval, a return request to return a previously purchased product. The second purchaser user device is associated with a second purchaser. The exchange facilitation system then determines whether the previously purchased product has the desired product characteristics. Responsive to a determination that the previously purchased product has the desired product characteristics, the exchange facilitation system transmits exchange instructions to the first and second purchaser user devices.

### BRIEF DESCRIPTION OF THE DRAWINGS

The invention can be more fully understood by reading the following detailed description together with the accompanying drawings, in which like reference indicators are used to designate like elements, and in which:

FIG. 1 is a schematic representation of a product purchasing system according to an embodiment of the invention;

FIG. 2 illustrates a sequence of operations in a prior art-based returned product exchange scenario;

FIG. 3 illustrates a sequence of operations in a returned product exchange scenario according to an embodiment of the invention;

FIG. 4 illustrates a sequence of operations in a returned product exchange scenario according to an embodiment of the invention;

FIG. 5 is a schematic representation of a user processing device usable in embodiments of the invention;

FIG. 6 is a schematic representation of an exchange facilitation data processing system according to an embodiment of the invention;

FIG. 7 is a flow diagram illustrating a method of facilitating product exchange transactions according to an embodiment of the invention; and

FIG. 8 is a flow diagram illustrating a method of facilitating product exchange transactions according to an embodiment of the invention.

### DETAILED DESCRIPTION OF THE INVENTION

While the invention will be described in connection with particular embodiments and manufacturing environments, it will be understood that the invention is not limited to these embodiments and environments. On the contrary, it is contemplated that various alternatives, modifications and equivalents are included within the spirit and scope of the invention as described.

It is clear that significant savings can be achieved by e-commerce (and even old-fashioned mail-order businesses) by matching up merchandise being returned with new product orders. Here-to-fore, however, this could only be accomplished based on a match at the time the new product is ordered. The present invention provides an automated mechanism through which product ordering users can be incentivized to delay their purchase of a particular product in anticipation of accepting a returned product directly from a returning customer.

The invention provides automated methods by which a merchant or independent facilitation entity can facilitate direct exchanges between product returning entities and product purchasing entities. This is accomplished by using data on return transactions and, in some cases, purchases of returned products, to create a machine learning-based tool for modeling and predicting return events for particular products in particular geographic regions. The results can include product return probability data that can be leveraged by the merchant or facilitation entity to determine whether and how to incentivize a product purchaser to delay their purchase. Typical incentives may include current product or future purchase price discounts, reduction or elimination of shipping costs, and reduction or elimination of delay due to lack of availability or back ordering.

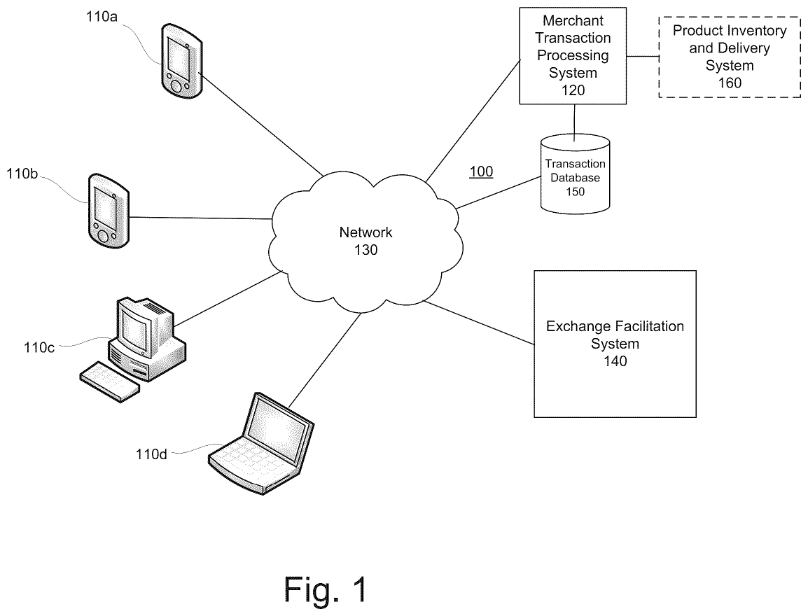

Embodiments of the invention may be best understood with reference to FIG. 1, which illustrates an exemplary product purchasing system 100 that encompasses a plurality of user devices 110a, 110b, 110c, and 110d, a merchant transaction processing system 120, an exchange facilitation data processing system 140 and a transaction information database 150. In the illustrated example, the user devices 110, the merchant transaction processing system 120, and the exchange facilitation data processing system 140 are network-enable computer systems configured to communicate with each other via a communication network 130. While the exchange facilitation data processing system 140 of system 100 is illustrated as being separate from the merchant transaction processing system 120, it will be understood that these systems may be associated with the same merchant and may be closely linked or consolidated into a single processing system.

As referred to herein, a network-enabled computer system and/or device may include, but is not limited to any computer device, or communications device (or combination of such devices) including, a server, a network appliance, a personal computer (PC), a workstation, and a mobile processing device such as a smart phone, smart pad, handheld PC, or personal digital assistant (PDA). Mobile processing devices may include Near Field Communication (NFC) capabilities, which may allow for communication with other devices by touching them together or bringing them into close proximity.

The network-enabled computer systems used to carry out the transactions contemplated in the embodiments may execute one or more software applications to, for example, receive data as input from an entity accessing the network-enabled computer system, process received data, transmit data over a network, and receive data over a network. The one or more network-enabled computer systems may also include one or more software applications to notify an account holder based on transaction information. It will be understood that the depiction in FIG. 1 is an example only, and the functions and processes described herein may be performed by any number of network-enabled computers. It will also be understood that where the illustrated system 100 may have only a single instance of certain components, multiple instances of these components may be used. The system 100 may also include other devices not depicted in FIG. 1.

The network 130 may be any form of communication network capable of enabling communication between the transaction entities and the card processing system 100. For example, the network 130 may be one or more of a wireless network, a wired network or any combination of wireless network and wired network. The network 130 may be or include one or more of a fiber optics network, a passive optical network, a cable network, an Internet network, a satellite network, a wireless LAN, a Global System for Mobile Communication (“GSM”), a Personal Communication Service (“PCS”), a Personal Area Network (“PAN”), Wireless Application Protocol (WAP), Multimedia Messaging Service (MMS), Enhanced Messaging Service (EMS), Short Message Service (SMS), Time Division Multiplexing (TDM) based systems, Code Division Multiple Access (CDMA) based systems, D-AMPS, Wi-Fi, Fixed Wireless Data, IEEE 802.11b, 802.15.1, 802.11n and 802.11g or any other wired or wireless network for transmitting and receiving a data signal. The network 130 may utilize one or more protocols of one or more network elements to which it is communicatively coupled. The network 130 may translate to or from other protocols to one or more protocols of network devices. Although the network 130 is depicted as a single network, it will be appreciated that it may comprise a plurality of interconnected networks, such as, for example, the Internet, a service provider's network, a cable television network, corporate networks, and home networks.

Each user device 110 of the system 100 is associated with an e-commerce user. It will be understood that there may be any number of user devices 110 and associated users. Typical users are financial account holders having accounts with a financial institution and/or a merchant (e.g., a merchant associated with the merchant transaction processing system 120). In the example embodiments presented herein, an account holder may be any individual or entity having a primary account with an account administrator (e.g., a bank or primary card account processor). Each user device 110 may be a mobile device or other processor that can be used to carry out a purchase or return transaction. An account may be held by any place, location, object, entity, or other mechanism for performing transactions in any form, including, without limitation, electronic form. An account may be a financial account or a non-financial transaction account. In various embodiments, a card-facilitated account may be a credit card account, a prepaid card account, stored value card account, debit card account, check card account, payroll card account, gift card account, prepaid credit card account, charge card account, checking account, rewards account, line of credit account, credit account, mobile device account, or mobile commerce account. In some instances, the account holder may be a transaction processing entity such as a financial institution, credit card provider, or other entity that offers accounts to customers.

As will be discussed in more detail hereafter, the merchant transaction processing system 120 is configured to communicate with the user devices 110 over the network 130. In particular, the merchant processing system 120 is configured for receiving and processing product orders from users making on-line purchases with their user devices 110. For ordinary purchase transactions, the merchant processing system 120 processes the financial transaction and sends instructions to the merchant's product inventory and delivery system 160, which would then obtain the product (e.g., from a warehouse) and ship it to the purchaser. For instances where the purchaser subsequently wishes to return the delivered product, the merchant processing system may be configured to receive and process return requests and provide instructions to the purchaser to return the product to the inventory and delivery system 160. Information on both purchase and return transactions may be stored by the merchant processing system 120 in a transaction database 150.

In the system 100, however, the merchant processing system 120 may also be configured to communicate with an exchange facilitation system 140. As will be discussed in more detail, the exchange facilitation system 140 may be configured to evaluate purchase transaction information and make recommendations and/or determinations regarding the possibility of offering a purchasing user incentives to consider accepting a returned product rather than a new item from inventory. The exchange facilitation system 140 may be configured to use data from the transaction database 150 to make these recommendations and determinations. In some embodiments, the exchange facilitation system 140 may be configured to pass recommendation information to the merchant transaction processing system 120, which may then transmit offers to the user devices 110 of both product purchasing users and product returning users to facilitate returned product exchanges. In other embodiments, the exchange facilitation system 140 may be configured to communicate with user devices 110 to facilitate exchanges.

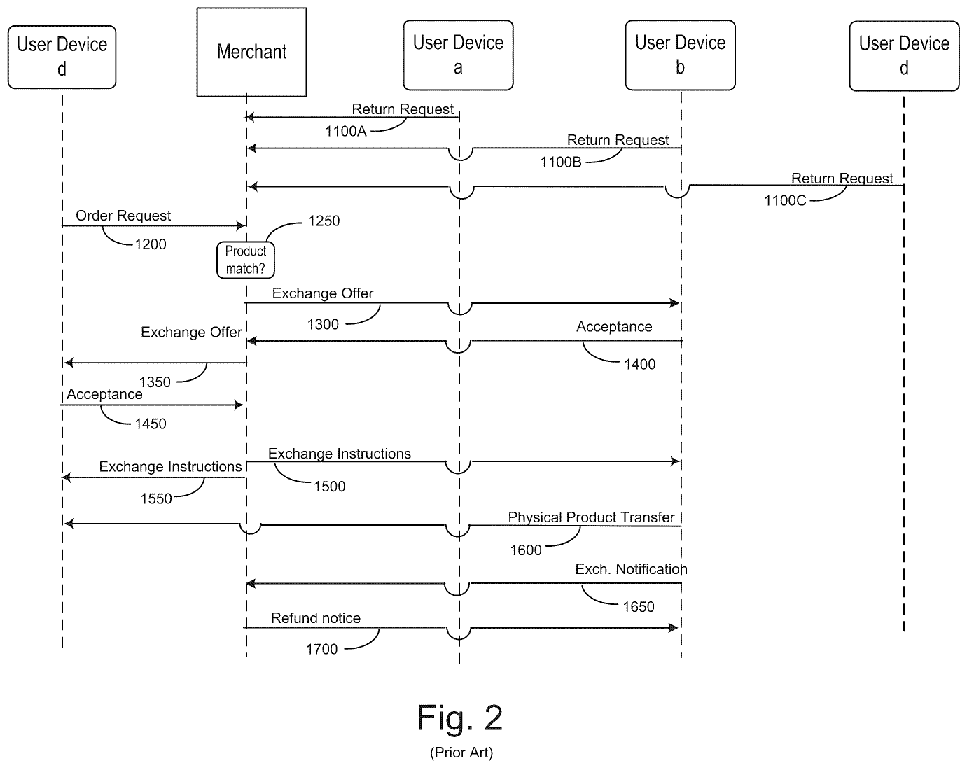

The sequence diagram of FIG. 2 illustrates an exemplary prior art e-commerce returned product exchange scenario. In this scenario, an account holder or other purchasing user of a user device (e.g., user device 110d of FIG. 1) wishes to purchase a product through an e-commerce merchant transaction processing system (e.g., system 120 of FIG. 1). The purchase sequence is initiated at 1200 when the purchaser User Device d transmits an order request to the merchant transaction processing system. At 1250, the merchant evaluates the purchase request to see if there is a pending return request for a product that exactly matches the ordered product. in the illustrated scenario, the merchant has received return requests from User Devices a, b, and c at 1100A, 1100B, and 1100C, respectively. It will be understood that, in this scenario, such requests must be retained without action for some period of time after they have been received in the hopes that a matching product order is placed. In the illustrated scenario, the merchant determines that the product identified in the return request received from User Device b matches the product in the order request received from User Device d. At 1300, the merchant transmits an exchange offer to User Device b suggesting that the returning user may wish to take advantage of enacting a transfer of the product to the ordering user rather than returning the product to the merchant. This may include an incentive such as a discount or simply point out an advantage such as the saving of shipping costs by an in-person drop-off. At 1400, the User Device b transmits an acceptance of the proposed exchange (pending acceptance by the ordering user).

At 1350 of the illustrated scenario, the merchant transmits an exchange offer to the ordering User Device d. This offer would likely include an incentive such as a discount or savings on a future purchase. At 1450, the ordering User Device d transmits an acceptance to the merchant. This may include account information for payment for the product or for receiving a partial refund of a payment made at the time of the order request. has received the physical product from the merchant associated with the transaction processing system and now wishes to return it to the merchant. At 1500, the merchant transmits exchange instructions to the returning User Device b. This could include information on how and where to ship the product or a location where the product can be dropped off for the ordering user to pick up. In the illustrated example, the merchant also transmits, at 1550, instructions to the ordering User Device d. This could include, for example, a location where the product can be picked up. Upon shipping or dropping off the product 1600, the returning user may transmit a notification to the merchant at 1650. The merchant then executes a transfer of a refund to an account of the returning user and sends a notice of such to User Device b at 1700.

It is readily apparent that the above-described prior art scenario relies entirely on the availability of a matching returned product at the time of ordering. While it may be possible to delay an order in the hopes of receiving a matching return, this is likely to result in significant customer dissatisfaction.

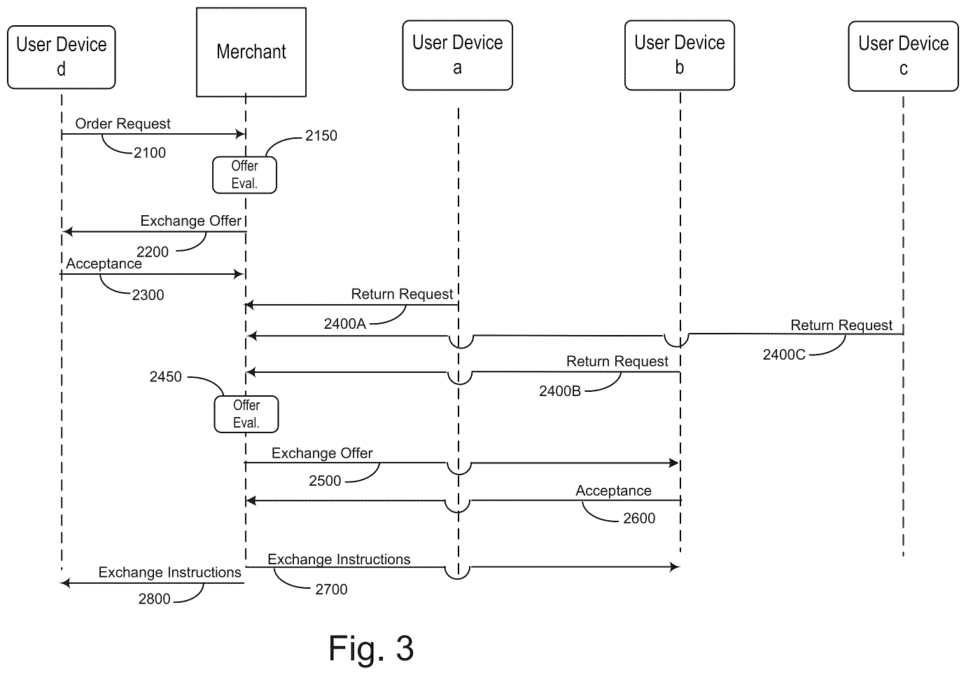

The sequence diagram of FIG. 3 illustrates an exemplary returned product exchange scenario that makes use of the invention. In the scenario set forth in FIG. 3, an account holder or other purchasing user of a user device (e.g., user device 110d of FIG. 1) wishes to purchase a product through an e-commerce merchant transaction processing system (e.g., system 120 of FIG. 1). The purchase sequence is initiated at 2100 when the purchaser User Device d transmits an order request to the merchant transaction processing system. This request typically would include all the specific characteristics of a particular product that the user wishes to purchase. At 2150, the merchant evaluates the purchase request and determines whether to present an offer to the user to induce the user to accept a returned item from another user in place of a newly shipped item. In various embodiments of the invention, this evaluation and determination may be made by an exchange facilitation system (e.g., system 140 of FIG. 1). The resulting offer could include an inducement such as a price discount on the current purchase or on a future purchase. Because the availability of a returned item is uncertain and may involve a delay, the offer could include a small incentive for accepting the delay (regardless of whether a matching returned item is found) and a larger incentive if a matching returned item is found and accepted by the purchasing user.

As will be discussed in more detail hereafter, the determination of whether to send a returned item offer to the purchasing user, as well as the form and magnitude of the incentive, may be made based on simulations run using a machine-learning-based model. Among other things, these simulations allow the merchant to make accurate predictions of the likelihood of a product having the ordered product characteristics being returned within a particular time frame and/or geographical area. The model, which is based, at least in part, on historical purchase and return data, may also be used estimate the likelihood of acceptance by an ordering user as a function of incentive. The model may account for various factors such as the nature of the product, user demographics, and geographic location.

In the scenario illustrated in FIG. 3, the merchant decides that it is worthwhile to offer the ordering user an incentive to delay their order against the possibility of accepting a returned item. Accordingly, at 2200, the merchant sends an exchange offer identifying the incentive(s) to the ordering User Device d. In a particular example, this offer could indicate that the user would receive a 5% discount if the user was willing to delay their purchase for two days to see if a matching product is returned in their geographic area. If a matching product is indeed returned and received by the ordering user, the ordering user would receive a 15% discount on the purchase. If no matching product is returned, the ordering user would receive a newly shipped item at a 5% discount.

At 2300 of the exemplary scenario, the purchasing user wishes to accept the offer and an acceptance message is transmitted by User Device d to the merchant. Over the ensuing time interval the merchant receives product return requests from User Devices a, b, and c at 2400A, 2400B, and 2400C, respectively. Each of these requests is evaluated by the merchant to see if the returned product matches the characteristics of the ordered product. In the illustrated scenario, the product identified in the return request from User Device b matches the product ordered by User Device d. At 2450, a determination may be made by the merchant as to whether to provide an exchange offer to user b with an incentive for the returning user to deliver (or otherwise make available) the returned item to the ordering user rather than returning the item to the merchant. As in the case with the ordering user, this determination and a determination of the size and magnitude of the inventive may be made based on acceptance probability modeling. At 2500, the merchant sends the exchange offer to User Device b. At 2600, the merchant receives an acceptance of the exchange offer from User Device b. At 2700 and 2800, the merchant sends exchange instructions to User Device b and User Device d, respectively. In some embodiments, these instructions may simply involve the mailing or shipping of the returned item from user b to user d. In other embodiments, user b may be instructed to drop off the item at an exchange location. Upon the item's arrival, user d could be advised that the item is available for pick-up. In either case, upon completion of the exchange, user b may be provided a refund (and, depending on the embodiment, any additional value offered as an exchange inducement) and the purchase transaction is completed with user d at the offered discount.

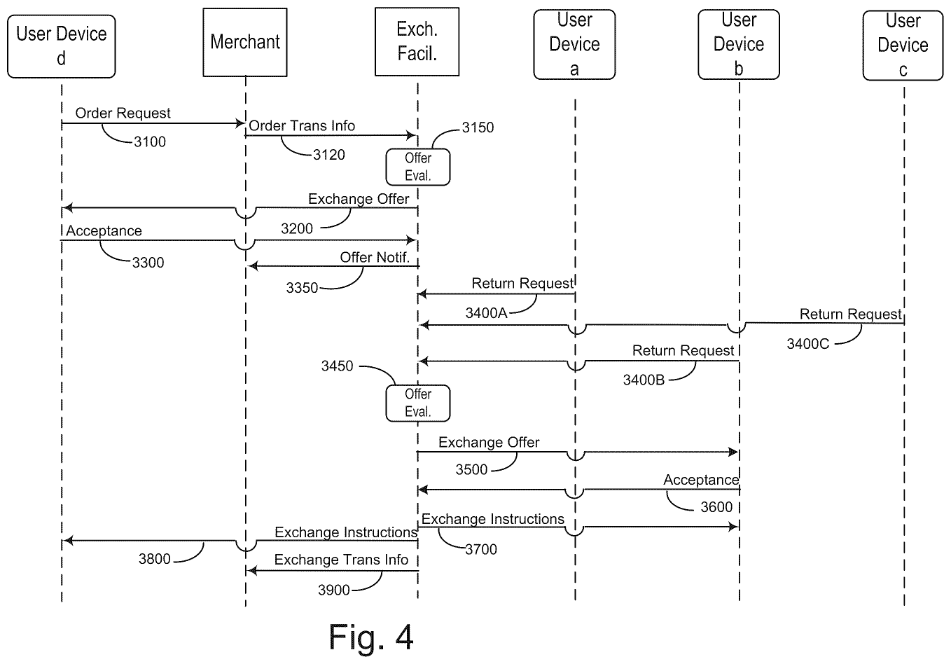

The sequence diagram of FIG. 4 illustrates another exemplary returned product exchange scenario that makes use of the invention. In this exemplary scenario, the exchange process is handled by an exchange facilitation system (e.g., system 140 of FIG. 1). The exchange facilitation system may be closely associated with or under the control of the merchant. In some cases, the exchange facilitation system may be closely associated with but separate from a new product order processing system of the merchant. In the scenario set forth in FIG. 4, an account holder or other purchasing user of a user device (e.g., user device 110d of FIG. 1) wishes to purchase a product through an e-commerce merchant transaction processing system (e.g., system 120 of FIG. 1). The purchase sequence is initiated at 3100 when the purchaser (User Device d) transmits an order request to the merchant transaction processing system. This request typically would include all the specific characteristics of a particular product that the user wishes to purchase. At 3120, the merchant transmits the order transaction information to the exchange facilitation system. In some embodiment of the invention, the original order request may be sent directly from the user device to the exchange facilitation system. At 3150, the exchange facilitation system evaluates the purchase request and determines whether to present an offer to the user to induce the user to accept a returned item from another user in place of a newly shipped item. The resulting offer could include an inducement such as a price discount on the current purchase or on a future purchase. The determination of whether to send a returned item offer to the purchasing user, as well as the form and magnitude of the incentive, may be made based on simulations run using a machine learning-based model.

In the scenario illustrated in FIG. 4, a determination is made that it is worthwhile to offer the ordering user an incentive to delay their order against the possibility of accepting a returned item. Accordingly, at 3200, the exchange facilitation system sends an exchange offer identifying the incentive(s) to the ordering User Device d. At 3300 of the exemplary scenario, the purchasing user accepts the offer with an acceptance message transmitted by User Device d to the exchange facilitation system. In some embodiments, the exchange facilitation system may optionally notify the merchant (and/or the merchant order processing system) of the exchange offer and acceptance at 3350. Over an ensuing time interval after acceptance, the exchange facilitation system receives product return requests from User Devices a, b, and c at 3400A, 3400B, and 3400C, respectively. Each of these requests is evaluated to see if the returned product matches the characteristics of the ordered product. In the illustrated scenario, the product identified in the return request from User Device b matches the product ordered by User Device d. At 3450, a determination may be made by the exchange facilitation system as to whether to provide an exchange offer to user b with an incentive for the returning user to deliver (or otherwise make available) the returned item to the ordering user rather than returning the item to the merchant. As in the case with the ordering user, this determination and a determination of the size and magnitude of the inventive may be made based on acceptance probability modeling. At 3500, the exchange facilitation system sends the exchange offer to User Device b. At 3600, the exchange facilitation system receives an acceptance of the exchange offer from User Device b. At 3700 and 3800, the exchange facilitation system sends exchange instructions to User Device b and User Device d, respectively. In some embodiments, the exchange facilitation system may optionally notify the merchant (and/or the merchant order processing system) of the full exchange transaction at 3900.

Details of system components usable in embodiments of the invention and, in particular, the system 100 will now be described.

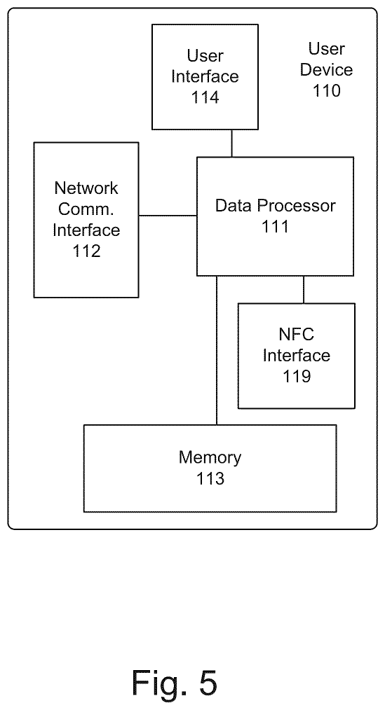

With reference to FIG. 5, the account holder user device 110 may be any computer device or communications device including a server, a network appliance, a personal computer (PC), a workstation, and a mobile interface device such as a smart phone, smart pad, handheld PC, or personal digital assistant (PDA). In a particular embodiment illustrated in FIG. 5, the user device 110 includes an on-board data processor 111 in communication with a memory module 113, a user interface 114, and a network communication interface 112. The data processor 111 may include a microprocessor and associated processing circuitry, and can contain additional components, including processors, memories, error and parity/CRC checkers, data encoders, anticollision algorithms, controllers, command decoders, security primitives and tamper-proofing hardware, as necessary to perform the functions described herein. The memory 113 can be a read-only memory, write-once read-multiple memory or read/write memory, e.g., RAM, ROM and EEPROM, and the user device 110 can include one or more of these memories.

The user interface 114 of the device 110 includes a user input mechanism, which can be any device for entering information and instructions into the user device 110, such as a touch-screen, keyboard, mouse, cursor-control device, microphone, stylus, or digital camera. The user interface 114 may also include a display, which can be any type of device for presenting visual information such as a computer monitor, a flat panel display, and a mobile device screen, including liquid crystal displays, light-emitting diode displays, plasma panels, and cathode ray tube displays.

The network communication interface 112 is configured to establish and support wired and/or wireless data communication capability for connecting the device 110 to the network 130 or other communication network. The network communication interface 112 can also be configured to support communication with a short-range wireless communication interface, such as Bluetooth.

In some embodiments, the user device 110 may include an NFC interface 119 configured for establishing NFC communication with other NFC-equipped devices. In some of these embodiments, the NFC interface 119 may be or include an NFC receiver configured for selectively activating a magnetic field for use in establishing near field communication with an NFC transmitter. The NFC interface 119 may be configured for establishing NFC communication when a passive NFC tag or other NFC-enabled device is brought into the magnetic field and within NFC communication range of the user device 110. The NFC interface 119 may be configured, in particular, for communication with an NFC-enabled smart transaction card when the card is brought within communication range of the user device 110.

In embodiments of the invention, the data storage/memory module 113 may have stored therein one or more programmed applications usable by the data processor 111 to conduct and/or monitor interactions between the user device 110 and content servers and/or other data processing systems over the network 130. The data storage/memory module 113 may, in particular, include a programmed application for implementing a network content browser in the data processor 111 and for facilitating interactive communications between the data processor 111 and remote processing systems and/or servers (e.g., merchant transaction processing system 120 and exchange facilitation system 140). In some embodiments of the invention, the memory 113 may have stored therein one or more applications usable by the data processor 111 to conduct and/or monitor transactions between the user device 110 and transaction processing devices or systems over the network 130. These applications may include instructions usable by the data processor 111 to identify transaction events, store event data in the memory 113, and communicate event data to a transaction information processing system (which could be or include the merchant transaction processing system 120), card account administrator data processing systems, and/or other processing systems (e.g., the exchange facilitation system 140).

In particular embodiments, the memory 113 may include a financial account application associated with a financial account provider configured for carrying out transactions on a card account associated with an account holder user of the user device 110. The application may, in particular, be configured for carrying out interactive communications/transactions with the administrator data processing system 140 and, in some embodiments, one or more transaction account processing systems 160. The application instructions may be configured for receiving, from the account holder via the user interface 114, login information for establishing authenticatable communication with the administrator data processing system 140. The login information may include an account identifier or other user identification and user authentication information.

The merchant transaction processing system 120 is an automated data processing system that may be configured for selective communication with the user devices 110 and/or the exchange facilitation system 140 via the network 130. The merchant transaction processing system 120 may be associated with a particular merchant entity and may be configured for executing one or more web server routines for transmitting content and performing operations in response to content request messages from user devices 110.

The merchant transaction processing system 120 may, in particular, be configured to conduct merchandise transactions with the user devices 110. Such transactions may include product purchases, product returns, and product exchanges. As part of such transactions, the merchant transaction processing system 120 may receive and respond to purchase, return, and exchange requests received from the user devices, arrange with an inventory processing system to ship new products, receive returned products, and replace exchanged products. The merchant processing system 120 may also be configured for communication with financial institution processing systems for processing financial settlement of transactions carried out with the user devices 110.

The merchant processing system 120 may be configured to store product transaction information in a transaction information transaction database 150. Information stored for each transaction may include account or other information for a user/account holder associated with the user device 110 involved in the transaction. User information may include contact information (mailing address, email address, phone numbers, etc.) and user preferences. It may also include information for a primary account (e.g., a bank or other cardholder administrator) for use product transactions. Transaction information may also include detailed information on a specific product at issue in the transaction, order and shipping date/time information, and geographic product location information. For certain transactions, additional types of information may be included in the transaction data record. In the case of a product return transaction, for example, the data record may include a reason for the return and/or a description of the condition of the product. Additional information could also include pricing and other incentives associated with the transaction.

For assistance in processing product orders, the merchant transaction processing system 120 may also be in communication with the merchant's product inventory and delivery system 160, which would encompass all of the infrastructure for manufacture, transport, storage, and delivery of merchant products. The merchant transaction processing system 120 may be configured to receive information from various components of the inventory and delivery system 160 to assure product availability and facilitate product transactions.

In embodiments of the invention, the merchant transaction processing system 120 may also be configured for communication with an exchange facilitation system 140 via the network 130. In some embodiments, the merchant system 120 may be configured to relay transaction information to and from a user device 110 and the exchange facilitation system 140.

The exchange facilitation system 140 is a network-enabled data processing system configured for managing certain product exchange decisions and facilitating the resulting product transfers. The exchange facilitation system 140 may be configured for incentivizing and facilitating the acceptance by product purchasers of products being returned by other purchasers. As will be discussed in more detail hereafter, this may be accomplished by using product transaction data to establish a machine learning-based decision model to determine incentives to offer to product purchasers.

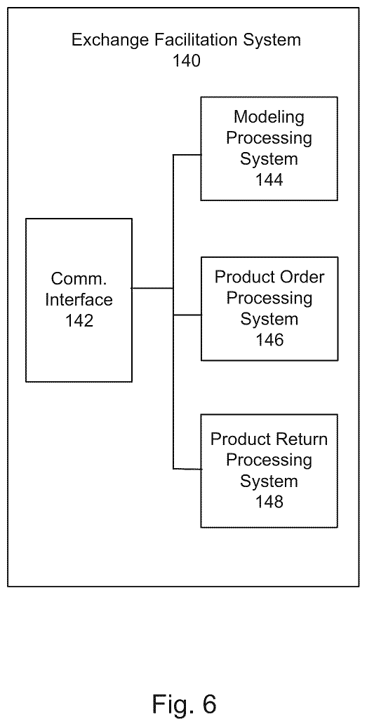

With reference now to FIG. 6, the exchange facilitation system 140 of embodiments of the invention may include a network communication interface 142 to allow selective communication with user devices 110 and the merchant transaction processing system 120 via the network 130. In some embodiments, the network communication interface 142 may also be used to access information stored in the transaction database 150. In the exemplary embodiment shown in FIG. 6, the exchange facilitation system 140 includes a modeling processing system 144, a product order processing system 146, and a product return processor 148, each of which may be configured to communicate over the network 130 via the network communication interface 142.

In embodiments of the invention, the modeling processing system 144 may include one or more data processors configured to receive or otherwise obtain product transaction information for large numbers of transaction from the transaction database 150 and use such information to create models of consumer behavior in relation to the products marketed by the merchant (or merchants) associated with the merchant transaction processing system 120. In some embodiments, the modeling processing system 144 may also obtain information on product availability from the merchant data processing system 120. Such information could include, for example, a full product catalog and information on current location and inventory of various merchant products.

The predictive models may be constructed using historical data for similar transactions involving similar or identical products and can include a wide range of variables such as consumer demographics (e.g., age, gender, location, etc.), time of year, product cost, product scarcity, product variations, etc. The models may be configured to provide probabilistic predictions regarding consumer response to offers presented in relation to certain product transactions. For example, a predictive model may be configured to leverage previous exchange behavior to determine, for a new order for a particular merchant product received from a user device 110 associated with a particular user, a relative likelihood that that user would be willing to accept an offer of a returned product having the same or similar characteristics as the ordered product. This model may also be used to determine changes in this likelihood as the result of varying types and levels of incentives and the length of time the user will wait to see if a matching product is received. Once determined, the offer acceptance probability landscape can be used to make an automated recommendation regarding an offer to be extended to the user to incentivize the user to accept the possibility of receiving a returned product.

An additional factor in the above recommendation, however, may be the relative likelihood of a return transaction for a matching product is received during the purchaser's wait period. In some embodiments, the modeling processing system 144 may be configured to use historical data to construct another predictive model (or add to the previous model) to provide probabilistic predictions of the likelihood that a product matching a newly ordered product will be returned within a certain timeframe and, if desired, within a certain geographic region. The model would use the product attributes of the newly ordered product and information on recent purchases of the same or similar products to predict the relative likelihood of a return for a given time period. Once determined, the likelihood of a matching returned product can then be fed back into determinations and recommendations relating to incentivizing the new purchaser. The model may also be used to determine a recommended waiting time period.

In many instances, it may be of value to incentivize a product returning user to go somewhat out of their way to provide the return product to a purchaser rather than send it back to the merchant. Embodiments of the invention may leverage past transaction information to make automated recommendations on the level and type of incentive to offer to a product returning user. Accordingly in some embodiments, the modeling processing system 144 may be configured to construct a probabilistic predictive model configured to determine a relative likelihood that a product returning user would be willing to make the returned product available to a purchasing user rather than returning the product to the merchant. This likelihood may be based on similar factors to those used to determine likelihood of exchange offer acceptance for a product purchaser. The model may also be used to determine changes in this likelihood as the result of varying types and levels of incentives. Once determined, the offer acceptance probability landscape can be used to make an automated recommendation regarding an offer to be extended to the returning user. The offer recommendation may include a particular combination of inducement characteristics and waiting time period.

In particular embodiments, the modeling processing system 144 may be configured to establish one or more machine learning models capable of providing new product purchaser offer acceptance predictions, product return probability predictions, and product returner offer acceptance predictions and to make incentive offer determinations or recommendations. The modeling processing system 144 may further be configured to use subsequent user responses to refine the machine learning model.

As previously discussed, the transaction database 150 comprises historical records regarding prior product purchase, return and exchange transactions. This information may be fed to a machine learning-based prediction model on a continuous or periodic basis or, in some embodiments, upon request or upon submission of new information to the transaction database 150. The transaction information from the transaction database 150 may be used to train the machine learning model to identify and establish the likely relative value of incentives that may be offered. The machine learning model may be configured to determine a likely outcome for various combinations of incentive type (e.g., present discount, future discount or coupon, free or low-cost shipping) and level for a product or product class. The model may be configured to, based on the historical transaction information and current product availability and timing parameters, establish a relative confidence level and/or a score reflecting a degree of likelihood of the outcome state.

In exemplary embodiments, the machine learning model may be an unsupervised learning model that makes use of any of various known algorithms. The exemplary model can utilize various neural networks, such as convolutional neural networks (“CNN”) or recurrent neural networks (“RNN”) to generate the machine learning model. In exemplary embodiments, a CNN can include one or more convolutional layers (e.g., often with a subsampling step), followed by one or more fully connected layers as in a standard multilayer neural network. CNNs can utilize local connections, and can have tied weights followed by some form of pooling which can result in translation invariant features.

RNNs are a class of artificial neural network where connections between nodes form a directed graph along a sequence. This facilitates the determination of temporal dynamic behavior for a time sequence. Unlike feedforward neural networks, RNNs can use their internal state (e.g., memory) to process sequences of inputs. RNNs may include two broad classes of networks with a similar general structure, where one is finite impulse and the other is infinite impulse. Both classes of networks exhibit temporal dynamic behavior. A finite impulse recurrent network can be, or can include, a directed acyclic graph that can be unrolled and replaced with a strictly feedforward neural network, while an infinite impulse recurrent network can be, or can include, a directed cyclic graph that may not be unrolled. Both finite impulse and infinite impulse recurrent networks can have additional stored state, and the storage can be under the direct control of the neural network. The storage can also be replaced by another network or graph, which can incorporate time delays or can have feedback loops. Such controlled states can be referred to as gated state or gated memory, and can be part of long short-term memory networks (“LSTMs”) and gated recurrent units.

RNNs can be similar to a network of neuron-like nodes organized into successive “layers,” each node in a given layer being connected with a directed e.g., (one-way) connection to every other node in the next successive layer. Each node (e.g., neuron) can have a time-varying real-valued activation. Each connection (e.g., synapse) can have a modifiable real-valued weight. Nodes can either be (i) input nodes (e.g., receiving data from outside the network), (ii) output nodes (e.g., yielding results), or (iii) hidden nodes (e.g., that can modify the data en route from input to output). RNNs can accept an input vector x and give an output vector y. However, the output vectors are based not only by the input just provided in, but also on the entire history of inputs that have been provided in in the past.

For supervised learning in discrete time settings, sequences of real-valued input vectors can arrive at the input nodes, one vector at a time. At any given time step, each non-input unit can compute its current activation (e.g., result) as a nonlinear function of the weighted sum of the activations of all units that connect to it. Supervisor-given target activations can be supplied for some output units at certain time steps. For example, if the input sequence is a speech signal corresponding to a spoken digit, the final target output at the end of the sequence can be a label classifying the digit. In reinforcement learning settings, no teacher provides target signals. Instead, a fitness function, or reward function, can be used to evaluate the RNNs performance, which can influence its input stream through output units connected to actuators that can affect the environment. Each sequence can produce an error as the sum of the deviations of all target signals from the corresponding activations computed by the network. For a training set of numerous sequences, the total error can be the sum of the errors of all individual sequences.

The modeling processing system 144 may be configured to receive a request for an incentive recommendation from either the product order processing system 146 or the product return processor 148. The request may include information on the product involved and the ordering or returning user. The modeling processing system 144 may use the machine learning model to obtain offer acceptance predictions for varying incentives and, for each incentive combination, determine an associated relative confidence level or likely effectiveness score. The modeling processing system 144 may be configured to use predetermined criteria to rank the candidate incentive combinations. The modeling processing system 144 may use ranking and/or threshold criteria to determine which, if any, of the candidate incentive combinations should be offered. If a determination is made that an incentive should be offered, the modeling processing system 144 may send a positive request response to the requesting processor 146, 148 including identification of the particular incentive combination to be offered. If a determination is made that no incentive combination meets acceptance criteria, the modeling processing system 144 may return a negative response to the requesting processor 146, 148.

The modeling processing system 144 may be further configured to receive feedback information from the product order processing system 146 and the product return processor 148 regarding acceptance or decline of offered incentives. This information may be used by the modeling processing system 144 to update the machine learning model.

The product order data processing system 146 may include one or more data processors configured to receive product order transaction information from either or both the merchant transaction processing system 120 and user devices 110 via the network 130 and the communication interface 142. The product order information may be received in a product order request originating from a user device 110 and either transmitted directly to the exchange facilitation system 140 or relayed to the exchange facilitation system 140 by the merchant processing system 120. The product order transaction information typically includes all the specific characteristics of a particular product that a user of the user device 110 wishes to purchase from the merchant. The product order transaction information typically may also include information about the user/product purchaser. Such information may, in particular, include demographic and location information.

The product order data processing system 146 may be configured to use the product order transaction information to make a determination as to whether to present an offer to the user to induce the user to accept a returned item from another user in place of a completely new product. In support of this determination, the product order processing system 146 may send to the modeling processing system 144 a request to provide an offer recommendation based on the ordered product and user information. In some cases, the product order processing system 146 may request either or both an offer recommendation and information on the likelihood of a matching product being returned within a predetermined time interval (e.g., two days or one week from order receipt).

The offer recommendation received back from the modeling processing system 144 may be a positive recommendation that could include a suggested inducement (e.g., a price discount on the current purchase or on a future purchase, free shipping, etc.) and a proposed waiting period. In some embodiments, the recommendation may include a confidence value indicative of the likelihood of acceptance of the offer. The product order processing system 146 may be configured to compare the offer recommendation and confidence value to predetermined criteria to determine if the exchange offer should be sent to the user/product purchaser.

In some cases, the offer recommendation received back from the modeling processing system 144 may be a negative recommendation. This may occur, for example, when the model suggests that the likelihood of a matching product return within a reasonable interval is too small or that there is no reasonable incentive that is likely induce the purchaser to accept an exchange. In most cases, the product order processing system 146 would accept such a recommendation and no offer would be sent. In some embodiments, however, the product order processing system 146 may be configured to override the exchange offer recommendation if certain predetermined criteria are met.

The product order processing system 146 may be configured to establish an exchange offer based on the order recommendation and transmit it to the ordering user device 110 in an offer notification message. This message would provide the ordering user with the option to wait for a given time interval to see if a item matching the ordered product is returned. The message may also identify an inducement for the user to accept returned product rather than a new product from the merchant's inventory. The inducement may actually include a first inducement to wait for a possible return and a second inducement for actually accepting a returned product. The product order processing system 146 may also be configured to wait for a response from the user device 110. If no response is received within a defined time frame or if a negative response is received from the user device 110, the offer may be deemed by the system 146 to be declined. The product order processing system 146 may then process the transaction as a regular new product order or notify the merchant transaction processing system 120 that it should process the order as a regular new product order.

If the product order processing system 146 receives a positive exchange offer response (i.e., a response indicating that the user is willing to wait for a possible returned product), the product order processing system may initiate a wait interval and notify the product return data processing system to monitor return transactions for a matching product. In some embodiments, the product ordering system 146 may notify the merchant transaction processing system 120 of the accepted offer and the associated inducement.

The product return data processing system 148 may include one or more data processors configured to receive product return transaction information from either or both the merchant transaction processing system 120 and user devices 110 via the network 130 and the communication interface 142. The product return data processing system 148 may be configured to monitor or receive product return transaction requests and compare the characteristics of returned products to those of products ordered by users who have accepted returned product exchange offers. In particular embodiments, the product return data processing system 148 may be configured to receive, over the network, product return transaction information for a product return request received from a user device 110 during a product exchange wait interval. The product return transaction information may include information about the requesting user and information about the merchant product being returned. The product return data processing system 148 may be configured to compare the characteristics of the returned product to the characteristics of the newly ordered product. If the characteristics match, the system 148 may take additional actions toward connecting the returning user to the ordering user.

In some embodiments, the product return data processing system 148 may be configured to immediately transmit a notification to the returning user device 110 with a standard offer for the returning user to make the returned product available to the purchasing user. If an acceptance is received from the returning user device 110, the product return data processing system 148 would transmit exchange instructions to both the returning user device 110 and the ordering user device 110. If no response is received or if a negative response is received from the returning user device, the product return data processing system 148 would continue monitoring for matching returned products until the end of the waiting interval.

In some embodiments, the product return data processing system 148 may be configured to determine the location of the product returning user or user device 110 and compare it to the location of the product ordering user or user device 110 or to a desired delivery location included in the order request. The system 148 may be further configured to take actions to connect the returning user with the ordering user only if the two locations meet predefined proximity criteria. Such criteria could include for example, the two locations being within a predefined distance of one another or both locations falling within a predefined geographic region, If the criteria is not met, the product return data processing system 148 would take no action in response to the product return request.

In some embodiments, the product return data processing system 148 may be configured to determine a second product exchange offer that can be extended to a product returning user. In support of this determination, the product return data processing system 148 may obtain, from the modeling data processing system 144, a second exchange offer recommendation. This second recommendation would be based on information on the product returning user and information on the product being returned. The second exchange offer recommendation received back from the modeling data processing system 144 could include a proposed inducement that may be offered to the returning user. The inducement would generally be tailored to compensate the returning user for the any inconvenience associated with getting the returned product to the ordering user rather than returning it to the merchant. The machine learning-based tool used by the modeling data processing system 144 may be configured to determine, based on past returner behavior and, in some cases, the past behavior of the particular returning user, a minimum inducement that would provide a reasonable likelihood of acceptance by the returning user.

The recommended inducement received from the modeling data processing system 144 could be, for example, a discount or coupon for a future purchase from the merchant. The recommendation from the modeling system 144 may also include a likelihood of acceptance parameter and/or a confidence level relating to the offer. The product return data processing system 148 may be configured to establish a second exchange offer based on the second exchange offer recommendation and transmit it in an offer notification message to the returning user device 110. If no response is received or if a negative response is received from the returning user device 110, the product return data processing system 148 would continue monitoring for matching returned products until the end of the waiting interval. If an acceptance is received from the returning user device 110, the product return data processing system 148 would transmit exchange instructions to both the returning user device 110 and the ordering user device 110.

In embodiments where the product order data processing system 146 and the product return data processing system 148 extend offers based on model-generated recommendations from the modeling data processing system 144, the product order data processing system 146 and the product return data processing system 148 may each be configured to return offer response feedback information to the modeling data processing system 144 for use in updating the machine learning-based model. The feedback information would include information tying a specific inducement offer to the recommendation, the product information, and information on the user to whom the offer was extended. The feedback information would also include an indication of the response from the user (e.g., acceptance, refusal, or “no response”). The systems 146, 148 may also be configured to provide feedback if the recommendation from the modeling data processing system 144 is not extended to the user for any reason.

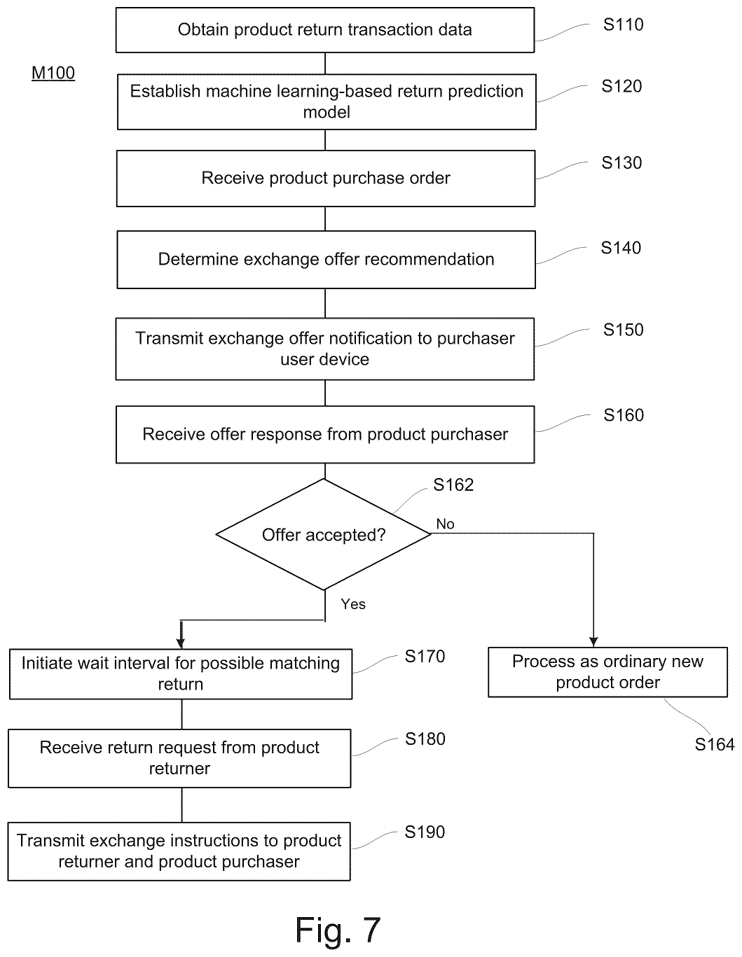

FIG. 7 illustrates an exemplary method M100 for a method of facilitating product exchange transactions according to an embodiment of the invention. Some or all of the actions of the method M100 may typically be carried out by an exchange facilitation data processing system such as the exchange facilitation system 140 of FIG. 1. At S110 of method M100, the exchange facilitation system may obtaining product return transaction data for a plurality of product return transactions. As used herein the term “product return transactions” includes transactions in which a previously purchased product is returned by the purchaser to the merchant from which it was purchased or conveyed by the purchaser to another purchaser. Typically, this data will be obtained from a transaction database storage facility, either directly or through a merchant transaction processing system. Transaction data may include account or other information for a user/account holder involved in the transaction, detailed information on a specific product at issue in the transaction, order and shipping date/time information, and geographic product location information. The transaction data may also include additional information such as a reason for a product return and/or a description of the condition of returned product. Additional information could also include pricing and other incentives associated with the transaction.

At S120, the exchange facilitation system may use the product return transaction data to establish a machine learning-based return transaction model. This model may be configured for making predictions regarding product return probability and exchange offer acceptance probabilities in relation to product purchases and returns. The return transaction model may also be configured to determine an exchange offer recommendation for a given set of product and purchaser characteristics. The exchange offer recommendation provides a basis for a decision on whether to propose acceptance of a returned product to a user who has submitted an order for a new product. If, based on the historical data and user characteristics, the model determines a reasonable likelihood of acceptance, the model may return a positive recommendation (i.e., a recommendation that an exchange offer be extended to the ordering user. In certain instances, the model may include a suggested inducement (e.g., a price discount on the current purchase or on a future purchase, free shipping, etc.) and a proposed waiting period with the recommendation. In some embodiments, the recommendation may include a confidence value indicative of the relative likelihood of acceptance of the offer. If the model determines that acceptance of an exchange offer is unlikely, even with reasonable inducements included in the offer, the model may return a negative recommendation (i.e., a recommendation that an exchange offer not be extended to the ordering user.

At S130, the exchange facilitation system receives a request to purchase a desired product having desired product characteristics. This may be received by the exchange facilitation system over a network a user device associated with a first purchaser and a purchaser account. In some instances, the request may be relayed to exchange facilitation system by a merchant transaction processing system. At S140, the exchange facilitation system determines an exchange offer recommendation using the machine learning-based return transaction model and information from the request to purchase. The recommendation may include an exchange offer that includes a proposed product exchange wait interval having a wait interval duration. The exchange offer may also include an inducement intended to increase the likelihood of offer acceptance by the first purchaser. At S150, the exchange facilitation system transmits an exchange offer notification including the exchange offer to the first purchaser user device. This may be transmitted directly to the purchaser user device over the network or may be transmitted to the merchant transaction processing system for relay to the purchaser user device.

At S160, the exchange facilitation system receives an exchange offer response from the purchaser user device. At S162, the exchange facilitation system evaluates the purchaser's response. If the response is negative (i.e., the purchaser does not want to accept a returned product rather than a new product), the exchange facilitation system may initiate an ordinary new product purchase at S164. In some embodiments, this may involve transmitting a notification to the merchant transaction processing system, which would then process the product order. If the purchaser's response is positive, the exchange facilitation system may initiate, at S170, a product exchange wait interval limited to the wait interval duration included with the exchange offer.

At S180, the exchange facilitation system may receive, during the wait interval, return request from a second purchaser user device associated with a second product purchaser. The return request may indicate that the second purchaser wishes to return a matching product (i.e., a product having the desired product characteristics). At S190, the exchange facilitation system may transmit exchange instructions to the first and second product purchasers. In some embodiments, these instructions may include directions for the second product purchaser to ship the matching product to the first product purchaser. In other embodiments, the instructions may include direction of the first and second purchasers to an exchange location where the matching product may be dropped off by the second purchaser and subsequently picked up by the first purchaser.

It will be understood that in the method M100, there may be many product return requests during the waiting period. Each of these requests may be evaluated by the exchange facilitation system to determine if the product being returned has the characteristics of the product ordered by the first product purchaser. It will also be understood that, even if a matching product is identified in a return request, additional actions may be required to secure agreement by the returning purchaser to proceed with an exchange.

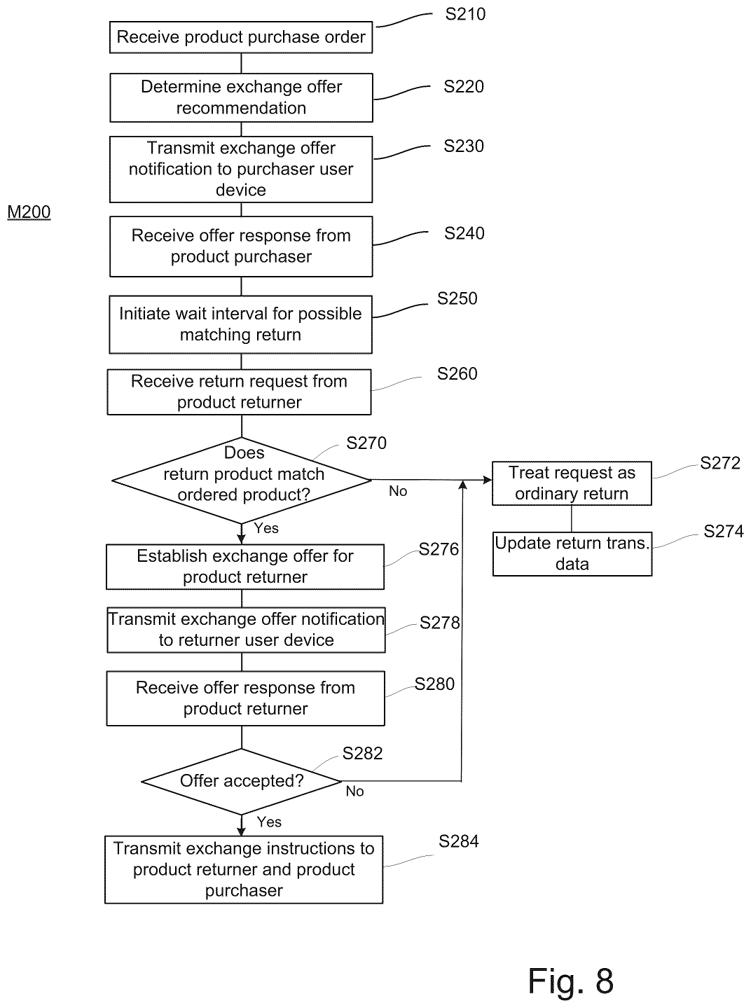

FIG. 8 illustrates an exemplary method M200 for a method of facilitating product exchange transactions according to an embodiment of the invention. Some or all of the actions of the method M200 may typically be carried out by an exchange facilitation data processing system such as the exchange facilitation system 140 of FIG. 1. The exchange facilitation system used to carry out the method M200 includes or has access to a machine learning-based return transaction model similar to that described above. At S210, the exchange facilitation system receives a request to purchase a desired product having desired product characteristics. This may be received by the exchange facilitation system over a network a user device associated with a first purchaser and a purchaser account. In some instances, the request may be relayed to exchange facilitation system by a merchant transaction processing system. At S220, the exchange facilitation system determines, by the exchange facilitation system, an exchange offer recommendation using the machine learning-based return transaction model and information from the request to purchase. The recommendation may include an exchange offer that includes a proposed product exchange wait interval having a wait interval duration. The exchange offer may also include an inducement intended to increase the likelihood of offer acceptance by the first purchaser. At S230, the exchange facilitation system transmits an exchange offer notification including the exchange offer to the first purchaser user device. This may be transmitted directly to the purchaser user device over the network or may be transmitted to the merchant transaction processing system for relay to the purchaser user device. At S240, the exchange facilitation system receives an exchange offer response from the purchaser user device. If the response is positive, the exchange facilitation system may initiate, at S250, a product exchange wait interval. To this point, the method M200 may be similar to the previous method M100.

At S260, the exchange facilitation system may receive, during the wait interval, a return request from a second purchaser user device associated with a second product purchaser. The return request may be received by the exchange facilitation system directly from the second purchaser user device over the network or may be relayed to the exchange facilitation system by the merchant transaction processing system. The return request may indicate that the second purchaser wishes to return a previously purchased product having its own set of characteristics. The return request may include, without limitation, information regarding any or all of the purchaser, the purchaser's location, the original purchase transaction, the product characteristics or identification, reasons for returning the product, and the condition of the product. At S270, the exchange facilitation system makes a determination as to whether the characteristics of the product being returned matches those of the product ordered by the first purchaser. If the characteristics do not match, the exchange facilitation system may initiate an ordinary product return procedure at S272. In some embodiments, this may involve transmitting a notification to the merchant transaction processing system, which would then process the product return.

If the exchange facilitation system determines that the characteristics of the product being returned match those of the ordered product. it may be deemed a matching product and the exchange facilitation system may proceed with a determination as to whether to propose an exchange to the product returning purchaser. This may include, at S276 determining a second exchange offer recommendation using the machine learning-based return transaction model and information from the request to purchase. In this case, the recommendation may include an exchange offer directed to the product returning purchaser. The recommendation may include a second recommended exchange offer that includes an inducement intended to increase the likelihood of offer acceptance by the product returning purchaser. At S278, the exchange facilitation system transmits a second exchange offer notification including the second exchange offer to the second purchaser user device. This may be transmitted directly to the second purchaser user device over the network or may be transmitted to the merchant transaction processing system for relay to the second purchaser user device. The second exchange offer notification may include information regarding steps that the product returning purchaser would need to take to in order to convey the previously purchased product to the ordering user.

At S280, the exchange facilitation system receives an exchange offer response from the second purchaser user device. At S282, the exchange facilitation system evaluates the purchaser's response. If the response is negative (i.e., the product returning purchaser prefers to return the product to the merchant over conveying the product to the ordering user), the exchange facilitation system may initiate an ordinary product return procedure at S272. If, however, the response is positive, the exchange facilitation system may transmit, at S284, exchange instructions to the first and second product purchasers. In some embodiments, these instructions may include directions for the second product purchaser to ship the matching product to the first product purchaser. In other embodiments, the instructions may include direction of the first and second purchasers to an exchange location where the matching product may be dropped off by the second purchaser and subsequently picked up by the first purchaser.

In both of the methods M100 and M200, the exchange facilitation system may use predetermined criteria whether to accept, alter or decline an exchange offer recommendation from the machine learning-based model. Information on determinations to extend or not to extend an exchange offer to product ordering users and product returning users may automatically be fed back into the machine learning model. The methods M100 and M200 may also include actions to update the machine learning-based model based on acceptance or refusal of exchange offers by ordering and returning users. This effectively refines the capability of the model to determine optimum inducements for future exchange offers.

The present invention provides automated methods by which prospective on-line product purchasers may be incentivized to accept a returned product rather than a newly shipped product from a merchant and to connect these purchasers with other on-line patrons who wish to return matching products. These methods may use machine learning to determine optimum inducements that may be offered to both product purchasers and product returners to increase the likelihood of acceptance of a proposed exchange. The methods of the invention greatly enhance the efficiency of automated system used to process product transactions in addition to saving time and money for the merchant.

The systems and methods described herein may be tangibly embodied in one or more physical media, such as, but not limited to, a compact disc (CD), a digital versatile disc (DVD), a floppy disk, a hard drive, read only memory (ROM), random access memory (RAM), as well as other physical media capable of data storage. For example, data storage may include random access memory (RAM) and read only memory (ROM), which may be configured to access and store data and information and computer program instructions. Data storage may also include storage media or other suitable type of memory (e.g., such as, for example, RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives, and any type of tangible and non-transitory storage medium), where the files that comprise an operating system, application programs including, for example, web browser application, email application and/or other applications, and data files may be stored. The data storage of the network-enabled computer systems may include electronic information, files, and documents stored in various ways, including, for example, a flat file, indexed file, hierarchical database, relational database, such as a database created and maintained with software from, for example, Oracle® Corporation, Microsoft® Excel file, Microsoft® Access file, a solid state storage device, which may include a flash array, a hybrid array, or a server-side product, enterprise storage, which may include online or cloud storage, or any other storage mechanism. Moreover, the figures illustrate various components (e.g., servers, computers, processors, etc.) separately. The functions described as being performed at various components may be performed at other components, and the various components may be combined or separated. Other modifications also may be made.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

What is claimed is:

1. A method of facilitating product exchange transactions, the method comprising:
obtaining, by an exchange facilitation system, product return transaction data for a plurality of product return transactions, the data for each transaction including purchaser account information and returned product information;
establishing, by the exchange facilitation system, a machine learning-based return transaction model using the product return transaction data, the return transaction model being configured to determine an exchange offer recommendation for a given set of product and purchaser characteristics;
receiving, by the exchange facilitation system over a network from a first purchaser user device associated with a first purchaser and a first purchaser account, a request to purchase a desired product having desired product characteristics;
determining, by the exchange facilitation system, an exchange offer recommendation using the machine learning-based return transaction model and information from the request to purchase, the exchange offer recommendation including an exchange offer including a proposed product exchange wait interval having a wait interval duration;
transmitting, by the exchange facilitation system to the first purchaser user device, an exchange offer notification including the exchange offer;
receiving, by the exchange facilitation system from the first purchaser user device, an exchange offer response; and
responsive to receiving a positive exchange offer response, initiating, by the exchange facilitation system, a product exchange wait interval limited to the wait interval duration.

2. A method according to claim 1 further comprising,
receiving, by the exchange facilitation system over the network from a second purchaser user device during the product exchange wait interval, a return request to return a previously purchased product;
determining, by the exchange facilitation system, whether the previously purchased product has the desired product characteristics; and
responsive to a determination that the previously purchased product has the desired product characteristics, transmitting, by the exchange facilitation system, exchange instructions to the first and second purchaser user devices.

3. A method according to claim 2 further comprising, responsive to a determination that the previously purchased product matches the desired product;
transmitting, by the exchange facilitation system to the second purchaser user device, a returner exchange offer notification; and
receiving, by the exchange facilitation system from the second purchaser user device, a returner exchange offer response,
wherein the action of transmitting exchange instructions is carried out only upon receiving a positive returner exchange offer response.

4. A method according to claim 3 further comprising, responsive to a determination that the previously purchased product matches the desired product:
determining, by the exchange facilitation system, a returner exchange offer,
wherein the returner exchange offer notification includes the returner exchange offer.

5. A method according to claim 2 further comprising:
updating the machine learning-based return transaction model by the exchange facilitation system.

6. A method according to claim 1 wherein
the machine learning-based return transaction model is further configured for determining acceptance probability information that includes likelihood of acceptance of the exchange offer response as a function of a variable exchange offer parameter, and
the acceptance probability information is used by the exchange facilitation system to determine the exchange offer.

7. A method according to claim 6 further comprising:
responsive to receiving an exchange offer response, updating the machine learning-based return transaction model with the exchange offer response.

8. A method according to claim 1
determining, by the exchange facilitation system using the machine learning-based return transaction model and information from the request to purchase, a product return prediction including a probability value indicative of a likelihood of a return of a matching product having the desired product characteristics,
wherein the machine learning-based return transaction model is configured to use the product return prediction probability to determine the exchange offer recommendation.

9. A method according to claim 8 further comprising:
receiving, by the exchange facilitation system over a network from a second purchaser user device during the product exchange wait interval, a return request for a previously purchased product;
determining, by the exchange facilitation system, whether the previously purchased product has the desired product characteristics;
determining, by the exchange facilitation system, whether the previously purchased product is located within a predetermined area surrounding a desired delivery location; and
responsive to a determination that the previously purchased product has the desired product characteristics and is located within the predetermined area surrounding the desired delivery location, transmitting, by the exchange facilitation system, exchange instructions to the first and second purchaser user devices.

10. An automated exchange facilitation data processing system comprising
a modeling data processing system configured to
obtain product return transaction data for a plurality of product return transactions, the data for each transaction including purchaser information and returned product information; and
establish and maintain a machine learning-based return transaction model using the product return transaction data, the return transaction model being configured to determine an exchange offer recommendation for a given set of product and purchaser characteristics;
a product order data processing system configured to
receive, over a network, product order transaction information for a product order request received from a first purchaser user device associated with a first purchaser and a first purchaser account, the product order transaction information including first purchaser information and desired product information for a desired product having desired product characteristics,
obtain, from the modeling data processing system, a first exchange offer recommendation based on the first purchaser information and the desired product information,
establish a first exchange offer based on the first exchange offer recommendation, the first exchange offer including a proposed product exchange wait interval having a wait interval duration,
transmit, to the first purchaser user device, a first exchange offer notification including the first exchange offer,
receive, from the first purchaser user device, a first exchange offer response, and
responsive to receiving a positive exchange offer response, initiate a product exchange wait interval limited to the wait interval duration, and
a product return data processing system configured to
receive, over the network, product return transaction information for a product return request received from a second purchaser user device during the product exchange wait interval, the product return transaction information including second purchaser information and product return information relating to a previously purchased product,
determine whether the previously purchased product has the desired product characteristics, and
responsive to a determination that the previously purchased product has the desired product characteristics,
obtain, from the modeling data processing system, a second exchange offer recommendation based on the second purchaser information and the product return information,
establish a second exchange offer based on the second exchange offer recommendation,
transmit, to the second purchaser user device, a second exchange offer notification including the second exchange offer,
receive, from the second purchaser user device, a second exchange offer response, and
responsive to receiving a positive exchange offer response, transmit exchange instructions to the first and second purchaser user devices.

11. An exchange facilitation data processing system according to claim 10,
wherein the return transaction model is further configured to determine a product return probability for a given product for at least one time interval, and to use the product return probability to determine the exchange offer recommendation.

12. An exchange facilitation data processing system according to claim 11 wherein the return transaction model is further configured to determine the proposed product exchange wait interval for inclusion in the exchange offer recommendation.

13. An exchange facilitation data processing system according to claim 11 wherein the request to purchase a desired product includes a desired product delivery location, and the machine learning-based return transaction model is configured to determine the product return probability for a predetermined area surrounding a location specified by an ordering user.

14. An exchange facilitation data processing system according to claim 13 wherein,
the product return data processing system is configured to determine whether the previously purchased product is located within a predetermined range of the desired product delivery location, and
the actions carried out responsive to a determination that the previously purchased product has the desired product characteristics are carried out only in response to a determination that the previously purchased product is located within the predetermined range of the desired delivery location.

15. An exchange facilitation data processing system according to claim 10 wherein,
the product order data processing system is configured to transmit response information from the first exchange offer response to the modeling data processing system,
the product return data processing system is configured to transmit the return product information from the second exchange offer response to the modeling data processing system, and
the modeling data processing system is configured to update the machine learning-based return transaction model using the response information from the first and second exchange offer responses.

16. An exchange facilitation data processing system according to claim 10 wherein
the machine learning-based return transaction model is further configured for determining acceptance probability information that includes likelihood of acceptance of the exchange offer as a function of a variable exchange offer parameter, and to use the acceptance probability information to determine the first exchange offer.

17. A method of facilitating product exchange transactions, the method comprising:
receiving, by an exchange facilitation system, a product order data processing system over a network from a first purchaser user device associated with a first purchaser and a first purchaser account, a request to purchase a desired product;
determining, by the exchange facilitation system, desired product information including desired product characteristics for the desired product;
obtaining, by the exchange facilitation system from a modeling data processing system running a machine learning-based return transaction model, a product return prediction including a probability value indicative of a likelihood of a return of a matching product having the desired product characteristics;
transmitting, by the exchange facilitation system to the first purchaser user device, an exchange offer notification including an exchange offer based on the product return prediction, the exchange offer including a proposed product exchange wait interval having a wait interval duration;
receiving, by the exchange facilitation system from the first purchaser user device, an acceptance of the exchange offer;
responsive to receiving the acceptance, initiating, by the exchange facilitation system, a product exchange wait interval limited to the wait interval duration;
receiving, by the exchange facilitation system over the network from a second purchaser user device during the product exchange wait interval, a return request to return a previously purchased product, the second purchaser user device being associated with a second purchaser;
determining, by the exchange facilitation system, whether the previously purchased product has the desired product characteristics; and
responsive to a determination that the previously purchased product has the desired product characteristics, transmitting, by the exchange facilitation system, exchange instructions to the first and second purchaser user devices.

18. A method according to claim 17 wherein the machine learning-based return transaction model is configured to determine the product return prediction probability for a geographic area surrounding a purchaser location and wherein the method further comprises:
determining, by the exchange facilitation system, a purchaser location associated with the first purchaser and providing it to the modeling data processing system.

19. A method according to claim 18 further comprising:
determining, by the exchange facilitation system, whether the second purchaser is located within the geographic area surrounding the purchaser location associated with the first purchaser,
wherein the action of transmitting instructions to the first and second purchaser user devices is carried out only in response to a determination that the second purchaser is located within the geographic area surrounding the purchaser location associated with the first purchaser.

20. A method according to claim 18 wherein the exchange instructions include identification of a product exchange location within the geographic area.
